(19) United States
(12) Patent Application Publication
(10) Pub. No.: US 2010/0253782 A1
(43) Pub. Date: Oct. 7, 2010

(54) DEVICE AND METHOD FOR AUTOMATED VERIFICATION OF POLARIZATION-VARIANT IMAGES

(75) Inventor: Andre ELAZARY, Netanya (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(73) Assignee: LATENT IMAGE TECHNOLOGY LTD., Lod (IL)

(21) Appl. No.: 12/419,360

(22) Filed: Apr. 7, 2009

(51) Int. Cl. H04N 7/18; G06K 9/68; H04N 5/222

(52) U.S. Cl. 348/161; 382/218; 348/E07.085; 348/370

(57) ABSTRACT

A device for verifying polarization-variant images has first and second illumination arrangements deployed in fixed spatial relation to a camera to illuminate the camera's field of view. A polarizing arrangement is deployed so as to selectively overlie the second illumination source without overlying the first illumination source, thereby allowing switching between differing conditions of polarized illumination without requiring moving optical elements. Also disclosed are various methods employing such a device for authentication and fraud prevention. Alternative implementations employ two cameras with a single illumination arrangement.

### FIELD AND BACKGROUND OF THE INVENTION

The present invention relates to verification of the authenticity of an article and, in particular, it concerns devices and methods for automated verification of the authenticity of an article carrying a polarization-variant image.

Many approaches exist for rendering it difficult to copy or counterfeit various articles, ranging from the brand name of consumer goods through to tickets, identity cards, credit cards and the like. One of the most common approaches is inclusion within the article of a holographic image, such as is commonplace in credit cards. However, the technology required to copy holographic images is now not uncommon, thus rendering the holographic images unreliable as verification of authenticity.

An alternative class of authenticating markings is referred to herein as “polarization-variant images.” This term is used herein to refer to any and all markings which include content which is selectively visible when viewed under differing conditions of polarized illumination and/or viewing. This principle was suggested in U.S. Pat. No. 5,284,364 to Jain, and has been further developed and is commercially available in a range of products from Latent Image Technology (“LIT”) Ltd. (Israel). In the particular examples available from LIT, the images are invisible under normal, non-polarized viewing conditions, appearing as part of a uniform surface or transparent sheet. When viewed under polarized visualization, in this example typically implemented as being both illuminated and viewed through a circular polarizer, a clear image becomes visible.

The technology required to reproduce a polarization-variant image is not widespread, rendering such images highly effective as verification of authenticity. However, the mode of verification has until now been limited to manual inspection using a hand-held polarizer.

There is therefore a need for a device and corresponding method to allow automated verification of a polarization-variant image.

### SUMMARY OF THE INVENTION

The present invention is a device and method for automated verification of the authenticity of an article carrying a polarization-variant image.

According to the teachings of the present invention there is provided, a device for verifying a polarization-variant image comprising: (a) a camera for acquiring images of a field of view; (b) a first illumination arrangement including at least a first illumination source, the first illumination source being deployed in fixed spatial relation to the camera and configured to illuminate at least part of the field of view; and (b) a second illumination arrangement including at least a second illumination source, the second illumination source being deployed in fixed spatial relation to the camera and configured to illuminate at least part of the field of view with polarized light.

According to a further feature of the present invention, the polarized light is generated by a polarizing arrangement deployed so as to overlie the second illumination source without overlying the first illumination source.

According to a further feature of the present invention, each of the first and second illumination arrangements is implemented as a plurality of illumination sources deployed in a substantially symmetrical arrangement around an optical axis of the camera.

According to a further feature of the present invention, the plurality of illumination sources of the first and second illumination arrangements are deployed substantially on a circle centered on the optical axis of the camera.

According to a further feature of the present invention, the plurality of illumination sources of the first and second illumination arrangements are deployed on a single printed circuit board.

According to a further feature of the present invention, the polarizing arrangement includes a sheet of polarizing material deployed to overlie the plurality of illumination sources of the second illumination arrangement without overlying the plurality of illumination sources of the first illumination arrangement.

According to a further feature of the present invention, the sheet of polarizing material is deployed to additionally overlie the camera.

According to a further feature of the present invention, the polarizing arrangement includes a sheet of polarizing material deployed to overlie the second illumination source and the camera without overlying the first illumination source.

According to a further feature of the present invention, the first and second illumination sources are deployed for illumination of a rear side of a transparent object deployed in the field of view of the camera.

According to a further feature of the present invention, the first and second illumination sources are deployed on a single printed circuit board.

According to a further feature of the present invention, the camera includes a sensor chip, the sensor chip being deployed on the printed circuit board.

According to a further feature of the present invention, there is also provided a controller associated with the camera, with the first illumination arrangement and with the second illumination arrangement, the controller being configured to: (a) activate the first illumination arrangement and acquire a corresponding first sampled image from the camera; (b) activate the second illumination arrangement and acquire a corresponding second sampled image from the camera; and (c) compare the first and second sampled images as part of a verification process for the polarization-variant image.

According to a further feature of the present invention, there is also provided a feeder mechanism associated with the controller and configured for feeding an article carrying the polarization-variant image from an insertion position to a verification position within the field of view of the camera for acquiring the first and second sampled images.

According to a further feature of the present invention, there is also provided a magnetic strip reader associated with the controller and deployed for reading information from a magnetic strip associated with the article while the article is fed by the feeder mechanism.

According to a further feature of the present invention, there is also provided a reader associated with the controller and deployed for reading supplementary data associated with an article carrying the polarization-variant image, wherein the controller is further configured to derive data from at least one of the first and second sampled images and to compare the data with the supplementary data.

There is also provided according to the teachings of the present invention a method for verifying a polarization-variant image comprising the steps of: (a) acquiring a first sampled image of the polarization-variant image under non-polarized illumination; (b) acquiring a second sampled image of the polarization-variant image under polarized illumination; and (c) comparing the first and second sampled images as part of a verification process for the polarization-variant image, wherein the non-polarized illumination and the polarized illumination are generated, respectively, by first and second illumination arrangements deployed in fixed spatial interrelation in combination with a polarizing arrangement deployed so as to overlie the second illumination arrangement without overlying the first illumination arrangement.

According to a further feature of the present invention, the first and the second sampled images are sampled by a camera having an optical axis, and wherein each of the first and second illumination arrangements is implemented as a plurality of illumination sources deployed in a substantially symmetrical arrangement around the optical axis.

According to a further feature of the present invention, the plurality of illumination sources of the first and second illumination arrangements are deployed substantially on a circle centered on the optical axis of the camera.

According to a further feature of the present invention, the plurality of illumination sources of the first and second illumination arrangements are deployed on a single printed circuit board.

According to a further feature of the present invention, the polarizing arrangement includes a sheet of polarizing material deployed to overlie the plurality of illumination sources of the second illumination arrangement without overlying the plurality of illumination sources of the first illumination arrangement.

According to a further feature of the present invention, the sheet of polarizing material is deployed to additionally overlie the camera.

According to a further feature of the present invention, an article carrying the polarization-variant image is fed from an insertion position to a verification position for acquiring the first and second sampled images.

According to a further feature of the present invention, information from a magnetic strip associated with the article is read during feeding of the article.

According to a further feature of the present invention: (a) supplementary data associated with an article carrying the polarization-variant image is read; (b) data is derived from at least one of the first and second sampled images; and (c) the data is compared with the supplementary data.

According to a further feature of the present invention, the method is implemented using an automated verification device in data communication with a personal computer to provide an authentication signal indicative that a computer user is in possession of an authentic card.

There is also provided according to the teachings of the present invention a device for verifying a polarization-variant image comprising: (a) a first camera for acquiring images of a first field of view; (b) a second camera deployed in fixed spatial relation to the first camera for acquiring images of a second field of view at least partially overlapping the first field of view; and (c) an illumination arrangement including at least one illumination source, the illumination source being deployed in fixed spatial relation to the first and second cameras and configured to illuminate at least part of the area of overlap between the first field of view and the second field of view with polarized light, wherein one of the first and second cameras is deployed so as to be sensitive to illumination in a polarization-dependent manner.

According to a further feature of the present invention, polarization of the illumination and polarization-dependence of one of the cameras is achieved by deploying a polarizing arrangement overlapping the at least one illumination source and the one of the cameras.

### BRIEF DESCRIPTION OF THE DRAWINGS

The invention is herein described, by way of example only, with reference to the accompanying drawings, wherein:

FIG. 1 is a block-diagram of a device, constructed and operative according to the teachings of the present invention, for verifying a polarization-variant image;

FIG. 2 is a variant of the device of FIG. 1 implemented as a hand-held stand-alone device;

FIGS. 3A and 3B are schematic isometric views of a camera unit for use in the device of FIG. 1, shown in an assembled and an exploded state, respectively;

FIG. 4A is a front view of the camera unit of FIG. 3A showing the layout of a camera optical arrangement and a plurality of illumination sources;

FIG. 4B is a front view of a polarizer sheet configured for use in the camera unit of FIG. 3A;

FIG. 4C is a front view showing the polarizer sheet positioned so as to overlie the camera optical arrangement and selected illumination sources;

FIG. 5 is a flow diagram illustrating a verification method for implementation using the device of FIG. 1 or FIG. 2;

FIG. 6 is a flow diagram illustrating a two-stage verification method for implementation using the device of FIG. 1;

FIG. 7 is a variant of the device of FIG. 2 showing a device operating in back-lit transmission mode; and

FIG. 8 is a further variant of the device of FIG. 2 illustrating a two-camera implementation of the device.

### DESCRIPTION OF THE PREFERRED EMBODIMENTS

The present invention is a device and method for automated verification of the authenticity of an article carrying a polarization-variant image.

The principles and operation of devices and methods according to the present invention may be better understood with reference to the drawings and the accompanying description.

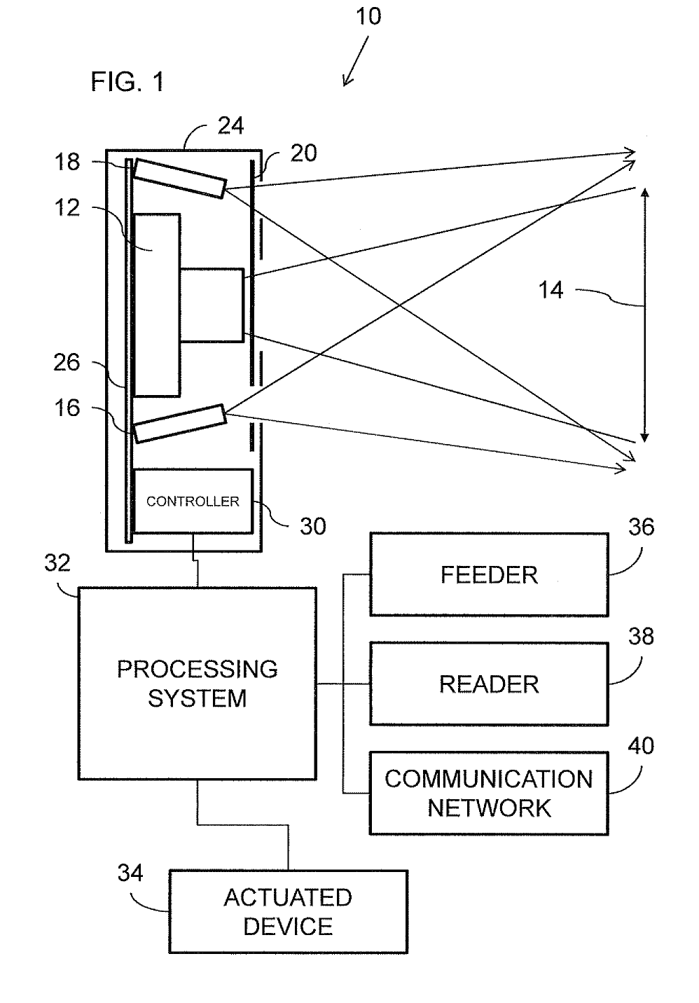

Referring now to the drawings, FIG. 1 shows a device, generally designated 10, constructed and operative according to the teachings of the present invention, for verifying a polarization-variant image. Generally speaking, device 10 includes a camera 12 for acquiring images of a field of view 14, and first and second illumination arrangements including at least corresponding first and second illumination sources 16 and 18, deployed in fixed spatial relation to camera 12, so as to each illuminate at least part of field of view 14. The second illumination arrangement is configured to illuminate with polarized illumination. Preferably, this is achieved by deploying a polarizing arrangement 20 so as to overlie second illumination source 18 without overlying first illumination source 16.

It will be immediately apparent that the structure of the device thus defines provides significant advantages. Specifically, by providing two illumination arrangements in fixed spatial relation to the camera together with suitable deployment of polarizing arrangement 20, it is possible to obtain images of an article within field of view 14 under differing illumination conditions simply by switching between illumination arrangements, without the structural complexity and lack of reliability that would be introduced by use of moving optical components. This and other advantages of the present invention will become clearer from the following detailed description.

At this stage, it will be helpful to define certain terminology as used herein in the description and claims. Firstly, the invention is used to verify the authenticity of articles bearing a polarization-variant image. The term “polarization-variant image” is used herein in the description and claims to refer to any and all markings which include content which is selectively visible when viewed under differing conditions of polarized illumination and/or viewing. More particularly, the polarization-variant images referred to here are images which are invisible or at least difficult to see when viewed under normal non-polarized illumination conditions, and which become clearly visible when suitable polarized visualization is used. Images falling within this definition include images made up from regions of polarizing material and regions of non-polarizing material, and images made up from regions with differing non-isotropic properties which serve to selectively rotate or otherwise change the properties of incident polarized light.

The type of polarized visualization required to view the image content clearly is chosen according to the type of image used. In an image which selectively polarizes incident radiation, a single polarizer on either the camera or the illumination would be sufficient to visualize the image. In preferred examples where the image has a selective effect on the properties of polarized light (e.g., rotating the plane of polarization or changing the sense of circular polarization), visualization is typically performed by use of a polarizer deployed in both the illumination and the camera. In such cases, use of non-polarized illumination is sufficient to render the image invisible, even if a polarizer is present over the camera.

The terms “polarizing arrangement” and “polarizer” are used herein to refer to any optical arrangement which selectively transmits or reflects light of a predefined polarization. For structural simplicity, a sheet of polarizing filter material is typically used. These terms are used herein generically to refer to linear polarizers and circular polarizers, unless stated otherwise.

The polarizer is referred to as “overlying” illumination sources and the camera. The term “overlie” is used herein in the description and claims to refer to overlap in the direction relevant for transmission or reception of radiation. Thus, a polarizer overlies a light source if it is positioned such that light transmitted by the light source passes through the polarizer and is filtered according. Similarly, a polarizer overlies the camera if light can only reach the sensor of the camera by passing through the polarizer.

The phrase “differing conditions of polarized illumination” is used to refer to any two scenarios of illumination between which the polarization status of the illumination varies. Examples include where a first illumination arrangement generates non-polarized light and a second illumination arrangement generates linearly or circularly polarized light. Also included are examples where first and second illumination arrangements both generate polarized illumination differing in the direction of linear polarization, in the sense of circular polarization, or between linear and circular polarization. In this context, the term “unpolarized” or “non-polarized” may be used loosely to refer to any radiation which does not satisfy the polarization requirements for visualizing the image, and may include light which is polarized in a manner incompatible with the required polarized visualization arrangements.

The term “image” is used in the description and claims to refer to any defined region which, under at least some visualization conditions, exhibits sufficient contrast to display a picture, pattern or other visibly discernable data.

The term “verifying” as applied to a polarization-variant image is used to refer to the process of verifying either the presence of, or in some cases specific content of; a polarization-variant image. In most cases, this includes comparing two images sampled under differing conditions of polarization. “Comparing” in this context includes any and all techniques for determining whether the two images are similar or dissimilar according to certain criteria, including but not limited to: direct comparison of the images by image processing techniques; comparison of each of the images against a reference image by image processing techniques; preprocessing of each image to derive data therefrom and comparing the derived data; and co-processing the two images and then processing the result.

Turning now to the features of the present invention in more detail, illumination sources 16 and 18 may be any sort of illumination sources. According to a particularly preferred implementation, illumination sources 16 and 18 are LEDs, preferred for their compactness, low power consumption and the convenience of integration on a PCB, as will be discussed below. The illumination sources may be monochromatic or multichromatic (e.g., white), and may operate at any range of wavelengths of visible or non-visible (e.g., infrared or ultraviolet) light.

In the preferred implementations described herein, polarized illumination is generated simply and at low cost by employing a polarizer deployed in the path of the illumination beam. In certain cases, it is possible to replace this arrangement with a laser diode or other device configured to directly generate polarized illumination of the type required.

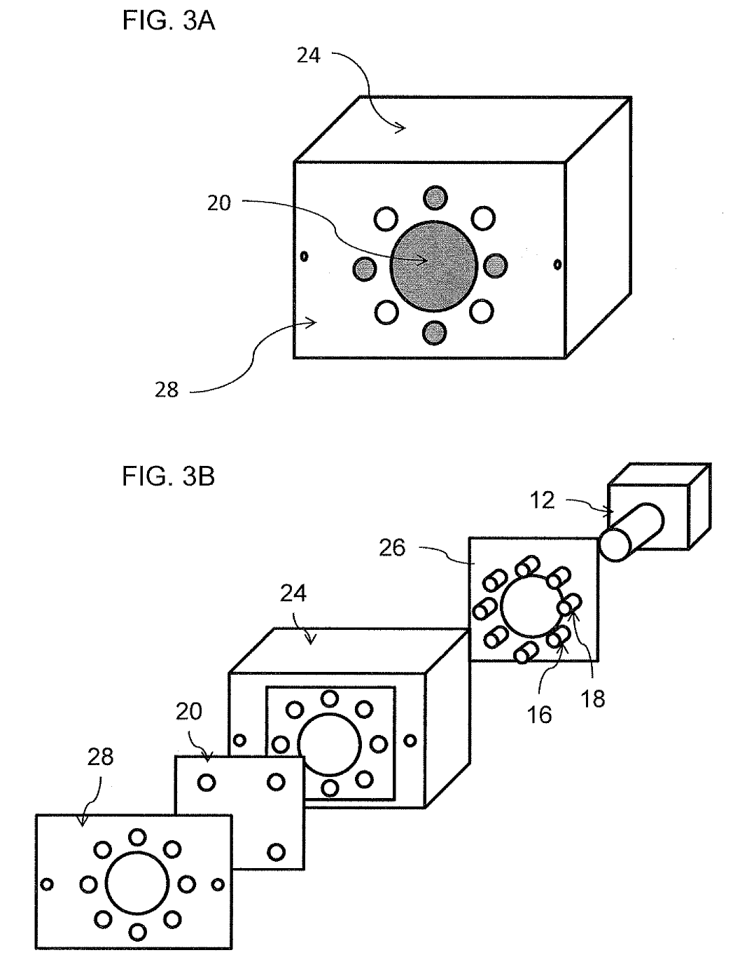

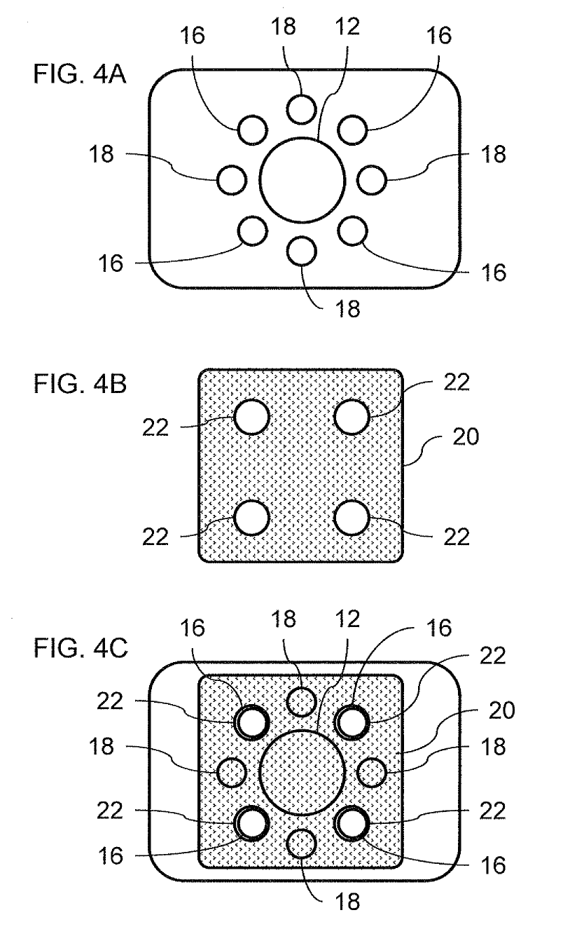

In order to facilitate comparison of images sampled under differing conditions of polarized illumination, it is preferably that the first and second illumination arrangements are deployed to generate illumination which is generally similar other than with respect to the polarization. To this end, each of the first and second illumination arrangements is preferably implemented as a plurality of illumination sources 16 or 18 deployed in a substantially symmetrical arrangement around the optical axis of camera 12. In a particularly preferred implementation as shown in FIGS. 3A-4C, illumination sources 16 and 18 are all deployed substantially on a circle centered on the optical axis of camera 12. Thus, in the example shown here, the first illumination arrangement includes a set of four illumination sources 16 while the second illumination arrangement includes a set of four illumination sources 18 alternating with illumination sources 16 around a circle centered on camera 12. This arrangement ensures relatively uniform and non-directional illumination by each illumination arrangement.

The radial spacing of illumination sources 16, 18 from the camera optical axis and the angle of mounting of the illumination sources are chosen as a function of the angular beam spread and intended range from camera 12 to the article to be examined. Typically, the illumination sources are mounted with a slight inward (i.e., converging) angle, preferably between about 3 degrees and about 15 degrees, relative to the optical axis of camera 12. By way of one non-limiting example, for a LED with a total beam width of about 20 degrees, it has been found effective to mount the LEDs with a 10 degree inward inclination relative to the optical axis. If the LEDs are disposed around a circle of diameter 2-3 cm, the overall illumination pattern becomes effective at a range of 3-4 cm, and reaches optimal uniformity at ranges upwards of roughly 6-8 cm.

Polarizing arrangement 20 is advantageously implemented as a single sheet of polarizing material deployed so as to overlie all of illumination sources 18 without overlying illumination sources 16. In the preferred implementation shown here, this is achieved by forming openings 22 in polarizing arrangement 20 positioned for alignment with illumination sources 16. FIG. 4C shows the deployed combination with illumination sources 16 aligned with openings 22 for direct non-polarized illumination and illumination sources 18 overlaid to provide filtered polarized illumination.

In a case in which polarized visualization is achieved by use of a polarizer for both the illumination and the camera, the sheet of material making up polarizing arrangement 20 is preferably deployed to additionally overlie camera 12, as shown in FIG. 4C. A particularly preferred instance of this case, suitable for example for visualizing images in commercially available products from Latent Image Technology Ltd., is where polarizing arrangement 20 is a circular polarizer.

Turning now briefly to FIGS. 3A and 3B, there is shown a preferred exemplary implementation of the camera unit of device 10. The camera unit is shown here with a housing 24 for receiving camera 12 and the illumination sources 16 and 18. As shown here, and in FIG. 1, it is considered particularly advantageous that the sensor chip of camera 12 and the illumination sources connect to a common printed circuit board (PCB) 26, thereby facilitating repeatable, low-cost manufacture of the unit. Polarizing arrangement 20 is preferably clamped in place on the front of the camera unit by an aperture plate 28 as shown.

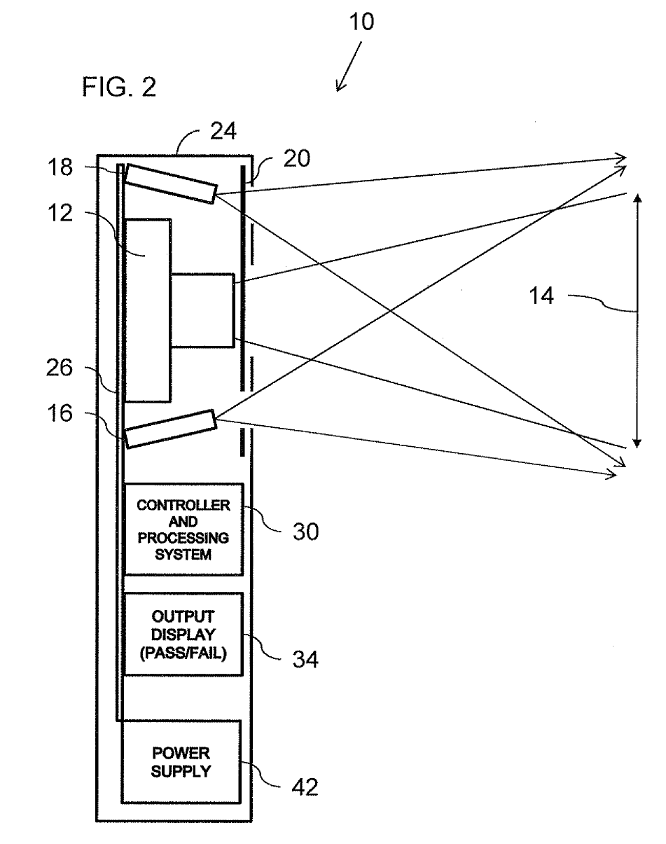

Turning now to the remaining features of device 10 illustrated in FIG. 1, there are shown a controller 30 and a processing system 32, as well as an actuated device 34. Controller 30 is shown here located within housing 24 while processing system 32 is shown here as a separately housed unit. Together provide basic operating functionality of the device, such as switching for selective actuation of the first and second illumination arrangements and synchronized actuation of camera 12 to acquire images under the differing polarized illumination conditions. Controller 30 and processing system 32 also provide various processing required for the verification process, as will be described below, as well as optionally coordinating with various external devices, also discussed below. One or both of controller 30 and processing system 32 include a processor, memory device, power supply components and other hardware components as required, all as will be clear to one ordinarily skilled in the art on the basis of the description herein. The subdivision of the components and functions between controller 30 and processing system 32 is a variable design consideration and may be, to a large extent, arbitrary. Thus, by way of example, it is possible to combine both controller 30 and processing system 32 as a unit separate from the camera unit, with camera control and illumination switching being controlled via externally supplied commands. At the other extreme, controller 30 and processing system 32 may be combined within the camera unit as will be exemplified below with reference to FIG. 2.

Actuated device 34 is the device to which the result of the verification process is to be provided. In a simplest case, actuated device 34 may be a display which is actuated to show the result of the verification process, typically as “PASS” or “FAIL”, and/or to display the content of, or data derived from, the visualized image This is useful in cases where device 10 is a tool used by an operator to verify articles.

By way of example, FIG. 2 shows a hand-held stand-alone verification device 10′ in which all processing is performed by the included controller/processing system 30, and the actuated device is an output display incorporated into the device. Power is preferably provided by an included battery power supply 42. Device 10′ is thus a simplified special case of the more general device 10 illustrated in FIG. 1.

In many cases, device 10 is integrated as part of an automated verification system for actuating a device 34 to perform an additional operation. The nature of actuated device 34 is tied to the particular application. Examples of suitable applications include, but are not limited to:
Automated Teller Machines (ATM's) where the article to be verified is a cash card, credit card or the like, and the actuated device is the cash dispenser or other functions of the ATM.
Credit card or charge card verification at point of sale or at home as a computer peripheral device for c-commerce applications, where the actuated device is a funds transfer device in communication with a bank or credit company.
Verification of an entrance ticket for accessing a sport or cultural event, where the actuated device 34 may be a turnstile.
Access Control to verify authorization to access restricted places, where actuated device 34 may be a door lock release mechanism.
Ticket verification for public transportation, such as trains and buses, where actuated device 34 may be an automatic barrier.
Sorting equipment in Banks such as check readers used by bank tellers.
Verified tracking through a barcode or other alpha numeric means, either printed alongside the image or incorporated within the image.
Verifiable Casino Chips.
Verifying latent images from a distance (for example in stores, or automatic barriers) by use of a suitably powerful polarized illumination source.

Additional components which may be present in at least some preferred implementations of device 10 include a feeder 36 for feeding articles from an insertion position to a verification position correctly aligned opposite camera 12, a reader 38 configured for reading supplementary data from the article to be verified, and a communication network 40 for facilitating communication between processing system 32 and a remote database or other central computer system. Feeder 36 may be any conventional feeder, chosen according to the intended application, such as the mechanisms used for feeding credit cards into and back out from ATMs, feeders for feeding tickets through automatic barriers or the like. Reader 38 may be any type of reader chosen according to the type of article to be read and the type of data storage used. Examples include, but are not limited to: magnetic strip readers, linear or 2D barcode scanners, smartcard chip readers, RFID interrogators, and conventional imaging systems for acquiring visible images in any suitable range of the spectrum. Communication network 40 may be any LAN or WAN, and may be based on a wired or wireless infrastructure, or any combination thereof. These additional components need not be dedicated components, and may in certain cases be a standard part of actuated device 34, for example, in the case of an ATM which typically includes a card feeder, a magnetic strip reader and a networked connection to central computers of the relevant financial organization.

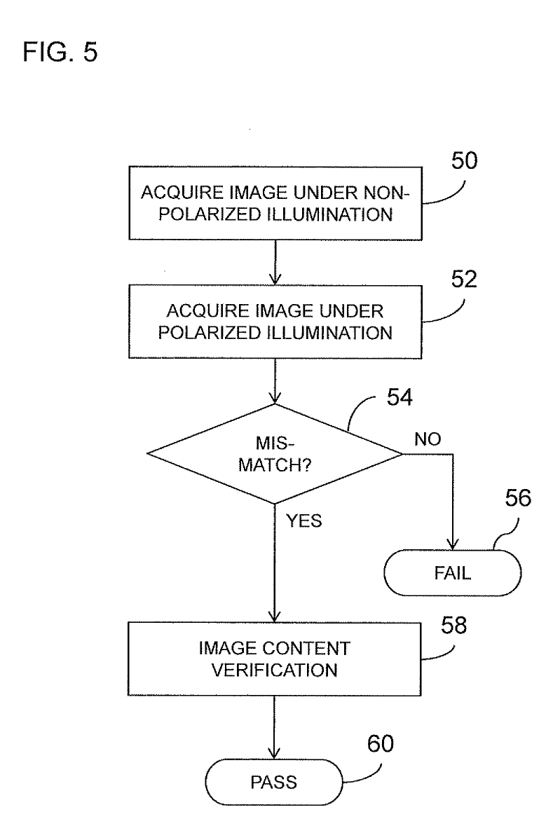

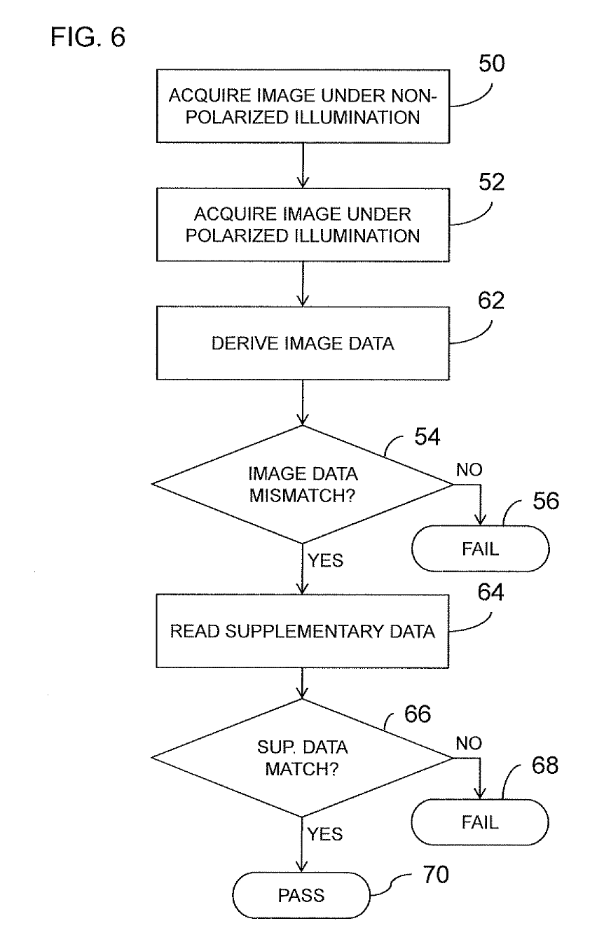

Turning to FIGS. 5 and 6, the operation of device 10, corresponding to the method of the present invention, will now be discussed. FIG. 5 shows an example of a typical verification process in which controller 30 activates selectively the first illumination arrangement and acquires a corresponding first sampled image from camera 12 (step 50), and activates selectively the second illumination arrangement and acquires a corresponding second sampled image from camera 12 (step 52). It will be appreciated that the order of steps S0 and 52 is arbitrary and may equally be reversed. These two images are then compared to check for a mismatch indicative that the image is indeed a polarization-variant image of the type sought (step 54). If the expected mismatch is not found, this indicates that there is either no image present or that the image is a normal visible image which appears in both sampled images. In such cases, a FAIL output is generated at step 56, either as a display to a user or as an output for suitable action (or inaction) of the actuated device 34, each case as appropriate for the particular application. For example, in an ATM, the card may either be confiscated or expelled from the machine if found to lack a required authorization image. In certain applications, a fail event may generate an alarm notification to a system operator or to security personnel to investigate a possible attempt at unauthorized entry or the like.

Optionally, in addition to verifying the presence of a polarization-variant image, certain particularly preferred implementations also check the content of the image (step 58). This check of content may be by comparing the image with one or more set of reference data. For example, one or more authorized images may be stored in a local or remote database, and each second sampled image may be compared to these images to determine whether there is sufficient correlation. Alternatively, the image may be indicative of a security code, for example represented as a 2D barcode, which can be derived from the second sampled image and is then processed as part of a verification scheme. One such verification scheme will be discussed further below with reference to FIG. 6.

Where the presence of a polarization-variant image was confirmed at step 54, and where the content of the image has been suitable verified at step 58 (or where step 58 is omitted), a PASS output is generated at step 60. Here too, the output may either actuate a display to a user or may directly actuate suitable action of the actuated device 34.

It will be noted that practical implementation of the above process involves numerous details which have not been addressed here in detail. For example, where a feeder is used, precautions must be taken to ensure that the article being verified reaches a well defined verification position in which the article is correctly oriented and located with the polarization-variant image within field of view 14. Furthermore, various image segmentation processing may be required to extract and normalize the region of the sampled images corresponding to the polarization-variant image for the purpose of deriving data or comparing against a database image. All such details are straightforward engineering tasks well within the capabilities of one ordinarily skilled in the art.

Turning finally to FIG. 6, this illustrates an elaboration of the process of FIG. 5 to include a further security precaution particularly relevant to fraudulent use of credit cards, debit cards, cash cards and the like. Specifically, a significant proportion of credit card fraud is perpetrated by use of an originally valid (e.g., stolen) card in which the magnetic strip has been re-recorded to contain stolen details of a card in someone else's possession. While the stolen card may itself have been canceled, there is nothing visibly wrong with the card which would indicate that the card is no longer valid. Similarly, when the card passes through a magnetic strip reader in an ATM or point of purchase terminal, a valid set of data for a card still in active use are read. The mismatch between the card and the magnetically recorded data thus goes undetected, allowing the fraudulent use to continue with periodic re-recording of stolen magnetic data.

To address this problem, an additional preferred aspect of the present invention illustrated in FIG. 6 includes an additional validation check which requires matching of data derived from the polarization-variant image against data stored in the magnetic strip (or smartcard chip) of the credit card. This requirement for matching between the polarization-variant image and the recordable data ensures that direct copying of recorded data from one card to another will result in an invalid combination which will fail the authentication check.

Referring now directly to FIG. 6, the method starts with image acquisition steps 50 and 52 as described in FIG. 5. Then, step 62 derives data from at least one of these image, typically directly from the second sampled image, but optionally including other processing such as division of one image by the other. A particularly preferred implementation for storing data within the image is a two-dimensional barcode. The image processing techniques required for locating and reading such a barcode within the second sampled image are well known and readily available. The derived data is typically a numerical code.

At step 54, the method checks for the expected mismatch between the sampled images to verify the presence of a polarization-variant image, as in FIG. 5. In this case, the mismatch verification may combined with step 62 as part of the data derivation. For example, successful data derivation from the second sampled image in combination with failed data derivation from the first sampled image may be a sufficient indication of the required mismatch. Alternatively, successful data derivation from a processed image generated by dividing one image by the other may also be a sufficient indication of the required mismatch. Where the card fails the mismatch test, a FAIL result is generated at step 56, as before.

The magnetic or otherwise recordable data is read from the card (step 64), before, during or after the steps described thus far, and at step 66, the method checks for the required match between the data derived at steps 62 and 64. In principle, if a polarization-variant image is generated for each individual card, it is possible to simply require that certain common information (e.g., the card number) appears in both sets of data. In practice, a requirement for uniqueness of each polarization-variant image may significantly increase manufacturing costs, so it is preferable to find alternative solutions.

One particularly preferred alternative solution is to provide a relatively large number (in excess of a hundred, and preferably in excess of a thousand) of different polarization-variant images each having different included data. One arbitrarily chosen images is then incorporated into each card. The data of that image is then processed, typically by an encryption technique, and most preferably in combination with at least some of the other data to be included in the magnetic strip, to generate a complementary security code which is recorded on the card together with the personal data. Since the security code is not related in a direct manner to the content of the image, only one having access to the encryption algorithm and parameters is able to generate the correct security code for any given combination of polarization-variant image data and personal card data. In order to limit access to the encryption algorithm, the verification process is preferably performed via networked communication by transmitting at least the data derived from steps 62 and 64 to the central computer system of the corresponding financial institution or to an outside authorization service provider which verifies compatibility of the two sets of data and returns a PASS or FAIL result. The method then proceeds to generate its FAIL output (step 68) or its PASS output (step 70), as before.

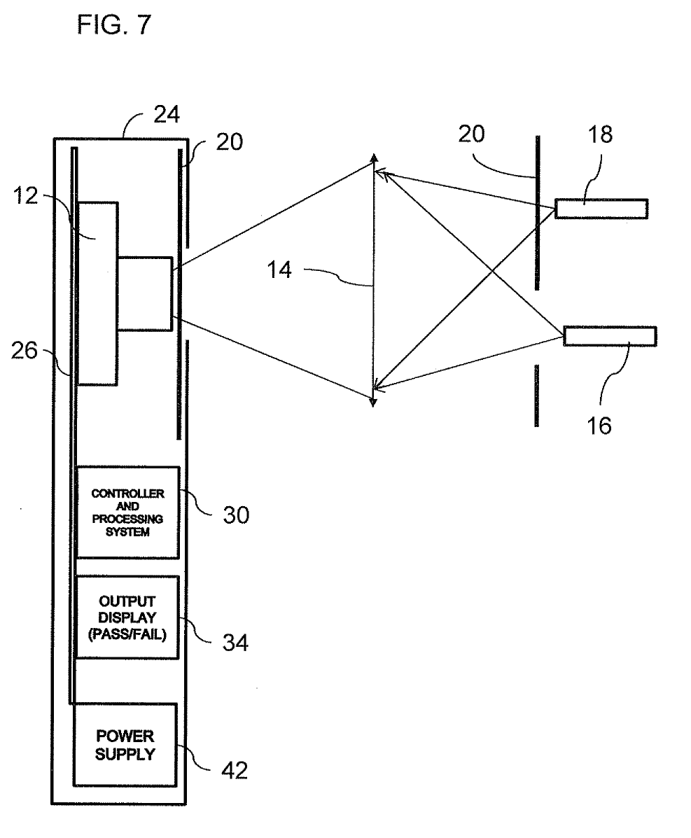

Turning now to FIG. 7, there is shown a variant of the device of FIG. 2 in which rear illumination is provided for verification by light transmission through the image-carrying article. This implementation is particularly relevant for polarization-variant images which are formed in transparent or translucent layers. Other than the geometrical deployment of the components, the structure and function of the device of FIG. 7 is equivalent to that of FIG. 2 described above, with equivalent elements being designated similarly.

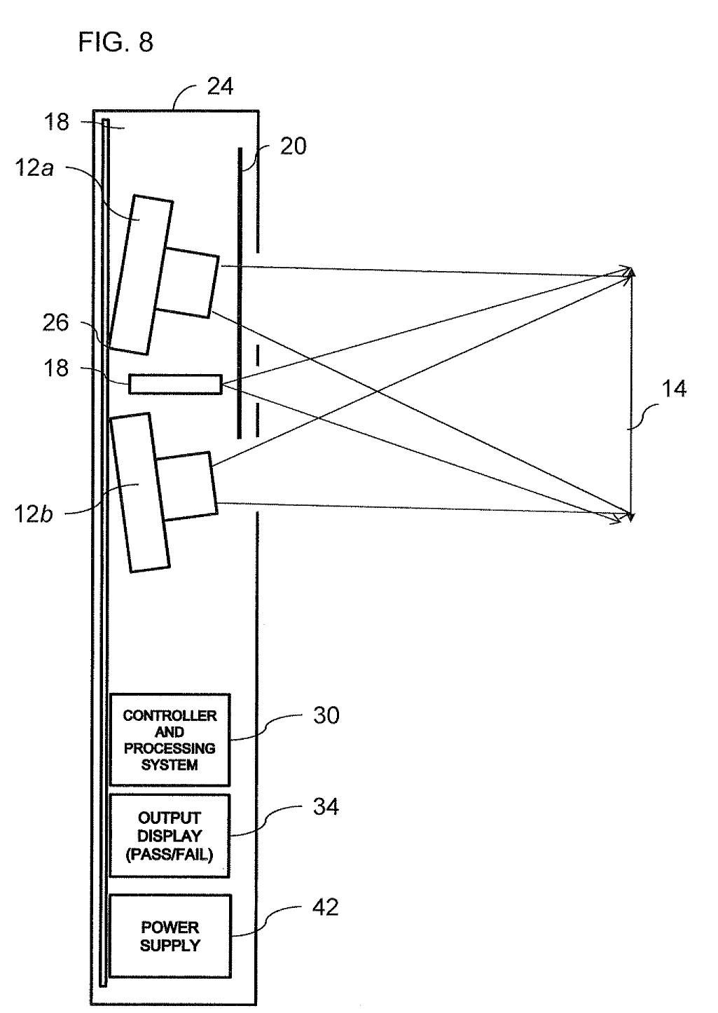

Turning finally to FIG. 8, it should be noted that a similar functionality may be achieved by using two cameras with a single illumination arrangement. In this case, a first camera 12a is deployed so as to overlaid by polarizer 20 while a second camera 12b samples an overlapping region without being overlapped by polarizer 20. The illumination arrangement, which may include any number of illumination sources 18, preferably generates constantly polarized illumination, such as by overlap of polarizer 20.

It will be appreciated that camera 12a samples images in which the polarized illumination has passed additionally through polarizer 20 after reflection from the image, thereby imaging the polarization-variant image, while camera 12b samples the reflected image directly. Although this arrangement may have somewhat higher cost than the implementation of FIG. 2, it may have advantages for particularly high throughput applications since the two images can be sampled simultaneously, and no switching between light sources is required.

It will be appreciated that the above descriptions are intended only to serve as examples, and that many other embodiments are possible within the scope of the present invention as defined in the appended claims.

What is claimed is:

1. A device for verifying a polarization-variant image comprising:
(a) a camera for acquiring images of a field of view;
(b) a first illumination arrangement including at least a first illumination source, said first illumination source being deployed in fixed spatial relation to said camera and configured to illuminate at least part of said field of view; and
(c) a second illumination arrangement including at least a second illumination source, said second illumination source being deployed in fixed spatial relation to said camera and configured to illuminate at least part of said field of view with polarized light.

2. The device of claim 1, wherein said polarized light is generated by a polarizing arrangement deployed so as to overlie said second illumination source without overlying said first illumination source.

3. The device of claim 2, wherein each of said first and second illumination arrangements is implemented as a plurality of illumination sources deployed in a substantially symmetrical arrangement around an optical axis of said camera.

4. The device of claim 3, wherein said plurality of illumination sources of said first and second illumination arrangements are deployed substantially on a circle centered on said optical axis of said camera.

5. The device of claim 3, wherein said plurality of illumination sources of said first and second illumination arrangements are deployed on a single printed circuit board.

6. The device of claim 3, wherein said polarizing arrangement includes a sheet of polarizing material deployed to overlie said plurality of illumination sources of said second illumination arrangement without overlying said plurality of illumination sources of said first illumination arrangement.

7. The device of claim 6, wherein said sheet of polarizing material is deployed to additionally overlie said camera.

8. The device of claim 2, wherein said polarizing arrangement includes a sheet of polarizing material deployed to overlie said second illumination source and said camera without overlying said first illumination source.

9. The device of claim 1, wherein said first and second illumination sources are deployed for illumination of a rear side of a transparent object deployed in said field of view of said camera.

10. The device of claim 1, wherein said first and second illumination sources are deployed on a single printed circuit board.

11. The device of claim 10, wherein said camera includes a sensor chip, said sensor chip being deployed on said printed circuit board.

12. The device of claim 1, further comprising a controller associated with said camera, with said first illumination arrangement and with said second illumination arrangement, said controller being configured to:
(i) activate said first illumination arrangement and acquire a corresponding first sampled image from said camera;
(ii) activate said second illumination arrangement and acquire a corresponding second sampled image from said camera; and
(iii) compare said first and second sampled images as part of a verification process for the polarization-variant image.

13. The device of claim 12, further comprising a feeder mechanism associated with said controller and configured for feeding an article carrying the polarization-variant image from an insertion position to a verification position within said field of view of said camera for acquiring said first and second sampled images.

14. The device of claim 13, further comprising a magnetic strip reader associated with said controller and deployed for reading information from a magnetic strip associated with the article while the article is fed by said feeder mechanism.

15. The device of claim 12, further comprising a reader associated with said controller and deployed for reading supplementary data associated with an article carrying the polarization-variant image, wherein said controller is further configured to derive data from at least one of said first and second sampled images and to compare said data with said supplementary data.

16. A method for verifying a polarization-variant image comprising the steps of:
(a) acquiring a first sampled image of the polarization-variant image under non-polarized illumination;
(b) acquiring a second sampled image of the polarization-variant image under polarized illumination; and
(c) comparing said first and second sampled images as part of a verification process for the polarization-variant image,
wherein said non-polarized illumination and said polarized illumination are generated, respectively, by first and second illumination arrangements deployed in fixed spatial interrelation in combination with a polarizing arrangement deployed so as to overlie said second illumination arrangement without overlying said first illumination arrangement.

17. The method of claim 16, wherein said first and said second sampled images are sampled by a camera having an optical axis, and wherein each of said first and second illumination arrangements is implemented as a plurality of illumination sources deployed in a substantially symmetrical arrangement around said optical axis.

18. The method of claim 17, wherein said plurality of illumination sources of said first and second illumination arrangements are deployed substantially on a circle centered on said optical axis of said camera.

19. The method of claim 17, wherein said plurality of illumination sources of said first and second illumination arrangements are deployed on a single printed circuit board.

20. The method of claim 17, wherein said polarizing arrangement includes a sheet of polarizing material deployed to overlie said plurality of illumination sources of said second illumination arrangement without overlying said plurality of illumination sources of said first illumination arrangement.

21. The method of claim 20, wherein said sheet of polarizing material is deployed to additionally overlie said camera.

22. The method of claim 16, further comprising feeding an article carrying the polarization-variant image from an insertion position to a verification position for acquiring said first and second sampled images.

23. The method of claim 22, further comprising reading information from a magnetic strip associated with the article during feeding of said article.

24. The method of claim 16, further comprising:
(a) reading supplementary data associated with an article carrying the polarization-variant image;
(b) deriving data from at least one of said first and second sampled images; and
(c) comparing said data with said supplementary data.

25. The method of claim 16, wherein the method is implemented using an automated verification device in data communication with a personal computer to provide an authentication signal indicative that a computer user is in possession of an authentic card.

26. A device for verifying a polarization-variant image comprising:
(a) a first camera for acquiring images of a first field of view;
(b) a second camera deployed in fixed spatial relation to said first camera for acquiring images of a second field of view at least partially overlapping said first field of view; and
(c) an illumination arrangement including at least one illumination source, said illumination source being deployed in fixed spatial relation to said first and second cameras and configured to illuminate at least part of the area of overlap between said first field of view and said second field of view with polarized light,
wherein one of said first and second cameras is deployed so as to be sensitive to illumination in a polarization-dependent manner.

27. The device of claim 26, wherein polarization of said illumination and polarization-dependence of one of said cameras is achieved by deploying a polarizing arrangement overlapping said at least one illumination source and said one of said cameras.
